(19) United States
(12) Patent Application Publication
(10) Pub. No.: US 2026/0149093 A1
(43) Pub. Date: May 28, 2026

(54) SECONDARY BATTERY

(71) Applicant: SAMSUNG SDI CO., LTD., Yongin-si (KR)

(72) Inventor: Yun Seok CHOI, Yongin-si (KR)

(21) Appl. No.: 19/348,947

(22) Filed: Oct. 3, 2025

(30) Foreign Application Priority Data
Nov. 27, 2024 (KR) 10-2024-0171599

(51) Int. Cl. H01M 50/133; H01M 10/613; H01M 10/625; H01M 50/107; H01M 50/119; H01M 50/121; H01M 50/152; H01M 50/249; H01M 50/342; H01M 50/531; H01M 50/586

(52) U.S. Cl. CPC H01M 50/133; H01M 10/613; H01M 10/625; H01M 50/119; H01M 50/121; H01M 50/152; H01M 50/249; H01M 50/3425; H01M 50/531; H01M 50/586; H01M 50/107

(57) ABSTRACT

A secondary battery comprises a case including an accommodation space in which an electrode assembly is accommodated. A cap assembly sealing an opening of the case. The case comprises an outer wall and an inner wall. The outer wall part includes a body portion and a bottom portion comprising an opening. The inner wall is disposed on the bottom portion, and the inner wall part comprises a hollow part corresponding to the opening. Thicknesses of the outer wall and the inner wall are different.

### CROSS-REFERENCE TO THE RELATED APPLICATION

The present application claims priority to and the benefit of Korean Patent Application No. 10-2024-0171599, filed on Nov. 27, 2024, in the Korean Intellectual Property Office, the entire disclosure of which is incorporated herein by reference.

### BACKGROUND

### 1. Field

Embodiments relate to a secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The information disclosed in this section is provided only for enhancement of understanding of the background of the disclosure and therefore it may contain information that does not form the prior art.

### SUMMARY

Embodiments provide a secondary battery that is safer.

A secondary battery according to an embodiment comprises a case comprising an accommodation space, the case including an outer wall and an inner wall, with the outer wall including a body portion and a bottom portion, with the bottom portion including an opening; an electrode assembly accommodated in the accommodation space; and a cap assembly sealing an opening of the case, the inner wall space is disposed on the bottom portion, the inner wall space comprises a hollow part adjacent to the opening, and thicknesses of the outer wall and the inner wall are different.

The accommodation space is formed between the outer wall and the inner wall.

The cap assembly comprises a cap up, a cap down under the cap up, and a safety vent between the cap up and the cap down, and the cap up, the cap down, and the safety vent comprise a hole corresponding to the opening of the bottom portion and the hollow part.

The secondary battery further comprises a first current collector plate positioned above the electrode assembly and a second current collector plate positioned under the electrode assembly, and the first current collector plate and the second current collector plate comprises a hole corresponding to the opening of the bottom portion and the hollow part.

The electrode assembly comprises a core part, and a diameter of the hollow part is greater than a diameter of the inner wall part.

The outer wall and the inner wall are formed from the same material.

The outer wall part and the inner wall are formed from different materials.

The outer wall part and the inner wall are formed from different metals.

A strength of the inner wall is greater than a strength of the outer wall.

The outer wall part comprises metal, and the inner wall part comprises resin.

The inner wall comprises an outer surface and an inner surface, and a protective layer is disposed on at least one of the inner surface or the outer surface.

A protective layer is disposed on the outer surface, and the protective layer comprises an insulating material.

A protective layer is disposed on the inner surface, and the protective layer comprises a material having a greater strength than the inner wall part.

A first protective layer is disposed on the outer surface, a second protective layer is disposed on the inner surface, the first protective layer comprises an insulating material, and the second protective layer comprises a material having a higher strength than the inner wall.

The inner wall comprises an outer surface and an inner surface of the inner wall part, and a groove is formed in at least one of the outer surface and the inner surface.

The groove is a notch extending along an outer diameter of the inner wall.

The inner wall comprises an outer surface and an inner surface, and the inner wall comprises at least one protrusion disposed on the outer surface.

The protrusion and the inner wall are formed from the same material.

The protrusion and the inner wall are formed from different materials.

The protrusion comprises an elastic material.

### BRIEF DESCRIPTION OF THE DRAWINGS

The accompanying drawings, which are incorporated in this specification, illustrate preferred embodiments and serve to further illustrate the technical ideas of the disclosure in conjunction with the detailed description of exemplary embodiments that follows, and the disclosure is not to be construed as limited to what is shown in such drawings. In the drawings:

FIG. 1 is a perspective view showing a secondary battery according to an embodiment.

FIG. 2 is a cross-sectional view taken along the region A-A′ of FIG. 1.

FIG. 3 is a top view of a case of the secondary battery according to an embodiment.

FIG. 4 is a cross-sectional view taken along the region B-B′ of FIG. 3.

FIGS. 5 to 9 are enlarged views of the region C of FIG. 4.

FIGS. 10 and 11 are cross-sectional views of the battery module including the secondary battery according to an embodiment.

FIGS. 12 and 13 are perspective views showing a battery pack including battery modules according to embodiments.

FIGS. 14 and 15 is a perspective view and a side view showing a vehicle including battery packs according to embodiments.

### DETAILED DESCRIPTION OF EXEMPLARY EMBODIMENTS

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

Hereinafter, secondary batteries according to embodiments will be described with reference to the drawings.

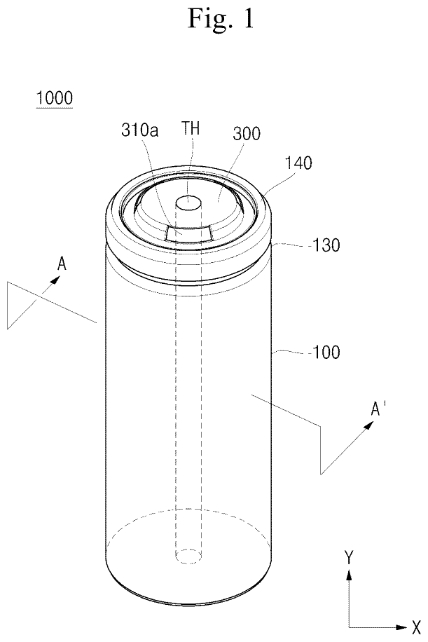

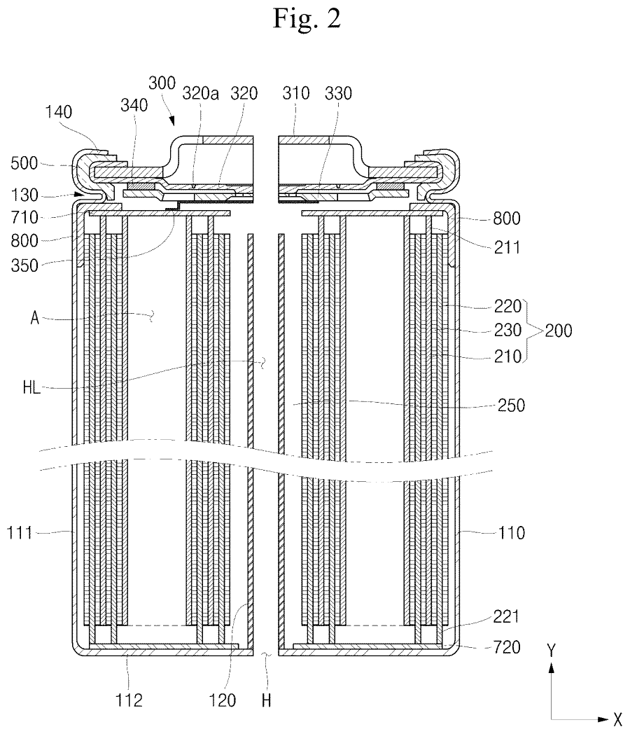

Referring to FIGS. 1 and 2, a secondary battery 1000 may include a case 100, an electrode assembly 200, a lead tab 350, a cap assembly 300, an insulating gasket 500, and current collector plates 710 and 720.

The case 100 forms the outer appearance of the secondary battery 1000. In detail, the case 100 may form the exterior of the secondary battery together with the cap assembly 300. The case 100 may include a space A for accommodating the electrode assembly 200 and an electrolyte.

The case 100 may be formed in various shapes. For example, the case 100 may be a circular shape. That is, the secondary battery may be a cylindrical secondary battery. The case 100 may include a conductive metal such as aluminum, an aluminum alloy, or nickel-plated steel.

The case 100 may include an outer wall part 110 and an inner wall part 120. The inner wall part 120 may include a hollow part HL. The accommodation space A may be formed between the outer wall part 110 and the inner wall part 120.

The case 100 will be further described in detail below.

The electrode assembly 200 may include a separator 230, and a first electrode 210 and a second electrode 220 positioned with the separator 230 interposed therebetween, and may be wound in a jelly-roll form. The electrode assembly 200 may be disposed in the accommodation space of the case.

The first electrode 210 includes a first current collector and a first active material layer on the first current collector. The first current collector includes a first surface and a second surface opposite to the first surface. The first active material layer may be disposed on at least one of the first and second surfaces of the first current collector. The first current collector may include a first uncoated portion 211 where the first active material layer is not provided.

The second electrode 220 includes a second current collector and a second active material layer on the second current collector. The second current collector includes a first surface and a second surface opposite to the first surface. The second active material layer may be disposed on at least one of the first and second surfaces of the second current collector. The second current collector may include a second uncoated portion 221 where the second active material layer is not provided.

The first electrode 210 may function as a positive electrode. In this case, the first current collector may include aluminum foil, and the first active material layer may include a transition metal oxide. The second electrode may function as a negative electrode. In this case, the second current collector may include copper foil or nickel foil, and the second active material layer may include graphite.

The separator functions to prevent short-circuiting between the first electrode 210 and the second electrode 220 while allowing the movement of lithium ions. For example, the separator 230 may include a polyethylene film, a polypropylene film, or a polyethylene-polypropylene film.

The cap assembly 300 may be disposed on the case 100. In particular, the cap assembly 300 may be disposed in an opening of the case 100. Accordingly, the case 100 may be sealed by the cap assembly 300. The cap assembly 300 may be fixed to the case 100 by the crimping part 140 and the insulating gasket 500. The cap assembly 300 may include a cap up (e.g., upper cap) 310, a safety vent 320, a cap down (e.g., lower cap) 330, and an insulating member 340, but is not limited to these examples and may be modified in various ways.

The cap up 310 may be positioned at the uppermost part of the cap assembly 300. The cap up may include a terminal part that protrudes upwardly and is connected to an external circuit, and an outlet 310a for discharging gas may be arranged around the terminal part.

The safety vent 320 may be located under the cap up 310. The safety vent 320 may include a protrusion part that protrudes convexly downwardly and is connected to the cap down 330, and at least one notch 320a may be formed in the safety vent around the protrusion part.

When gas is generated due to overcharging or abnormal operation of the secondary battery, the protrusion part is deformed upwardly by the pressure and separates from the cap down 330 while the safety vent is cut (e.g., bursts or tears) along the notch. The cut safety vent 320 may prevent the secondary battery from exploding by allowing for the gas to be discharged to the outside.

The cap down 330 may be located under the safety vent 320. The insulating member 340 may be located between the safety vent 320 and the cap down 330 to insulate the safety vent 320 and the cap down 330.

The first electrode 210 and the second electrode 220 generate lithium ions by an electrochemical reaction. The electrolyte enables lithium ions to move in the battery. The electrolyte may be a non-aqueous organic electrolyte that is a mixture of a lithium salt and a high-purity organic solvent. In other cases, the electrolyte may be a polymer including a polymer electrolyte or a solid electrolyte.

The electrode assembly 200 may include a core part 250. In detail, the electrode assembly 200 may be wound with the core part 250 formed at the center of the electrode assembly. When the electrolyte is injected into the case 100, the electrolyte may be easily be provided to the core part 250. And, when gas or heat is generated in the secondary battery, the gas or heat may easily move to outside of the secondary battery from the core part 250. The separator 230 may be disposed on the inner surface of the core part 250.

Current collector plates are disposed on the upper and lower portions of the electrode assembly 200. The current collector plates may include a first current collector plate 710 and a second current collector plate 720. The first current collector plate 710 may be disposed on the upper portion of the electrode assembly 200. In detail, the first current collector plate 710 may be disposed between the electrode assembly 200 and the cap assembly 300. The second current collector plate 720 may be disposed on the lower portion of the electrode assembly 200. More specifically, the second current collector plate 720 may be disposed between the electrode assembly 200 and the bottom portion 112 of the case. The area of the first current collector plate 710 may be less than or equal to the area of the upper surface of the electrode assembly. And the area of the second current collector plate 720 may be less than or equal to the area of the lower surface of the electrode assembly.

The first current collector plate 710 is connected to the first electrode 210. In particular, the first current collector plate 710 is electrically connected to the first uncoated portion 211. For example, the first current collector plate 710 and the first uncoated portion 211 may be coupled by welding.

The first current collector plate 710 may be connected to the cap assembly 300. In detail, the lead tab 350 may be disposed between the first current collector plate 710 and the cap assembly 300. A first end of the lead tab 350 and the first current collector plate 710 may be coupled by welding, and a second end of the lead tab 350 and the cap down 330 may be coupled by welding. Accordingly, the first current collector plate 710 and the cap assembly 300 may be electrically connected by the lead tab 350. The first current collector plate 710 may thereby form a passage for current flow between the first electrode 210 and the cap assembly 300. And the terminal part of the cap assembly may be a positive electrode.

The second current collector plate 720 is connected to the second electrode 220. In detail, the second current collector plate 720 is electrically connected to the second uncoated portion 221. The second current collector plate 720 and the second uncoated portion 221 may be coupled by welding, and the second current collector plate 720 may be connected to the bottom portion 112 of the case. For example, the second current collector plate 720 and the bottom portion 112 of the case may be coupled by welding. Thus, the second current collector plate 720 may form a passage for current flow between the second electrode 220 and the case 110. The case 110 may thereby function as a negative electrode.

An insulating member 800 may be disposed between the electrode assembly 200 and the body portion 111. More specifically, the insulating member 800 may be disposed between the body portion 111 and the first current collector plate 710. The electrode assembly 200 and the outer wall part 110 may be insulated by the insulating member 800. And the first current collector plate 710 and the outer wall part 110 may be insulated by the insulating member 800.

Above, a secondary battery including a first current collector plate and a second current collector plate has been described. However, embodiments of the present disclosure are not limited to such a configuration. For example, the secondary battery may not include the current collector plate. As another example, the first uncoated portion and the second uncoated portion may be directly connected to the cap assembly and the bottom portion, respectively. Or, the first uncoated portion and the second uncoated portion may be connected to the cap assembly and the bottom portion, respectively, through separate lead tabs.

The electrode assembly may be in the jelly-roll shape. Such an electrode assembly may repeatedly shrink and expand during charging and discharging. While deformation of the outer diameter of the electrode assembly is limited by the case, deformation of the inner diameter of the electrode assembly may be relatively large. Accordingly, mechanical stress resulting from deformation of the electrode assembly may be concentrated on the core of the electrode assembly.

The secondary battery according to the embodiment may include the case including an in the inner wall part. to solve the above-described problems resulting from deformation of the electrode assembly.

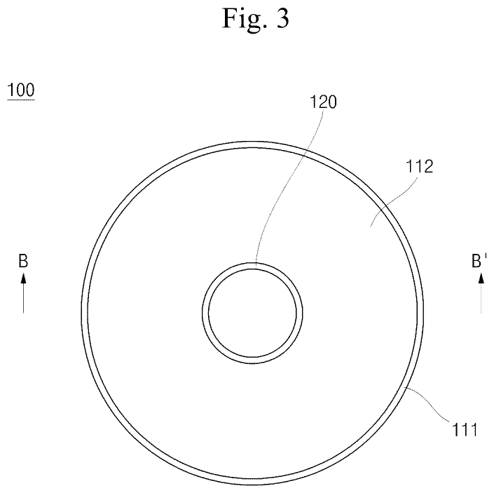

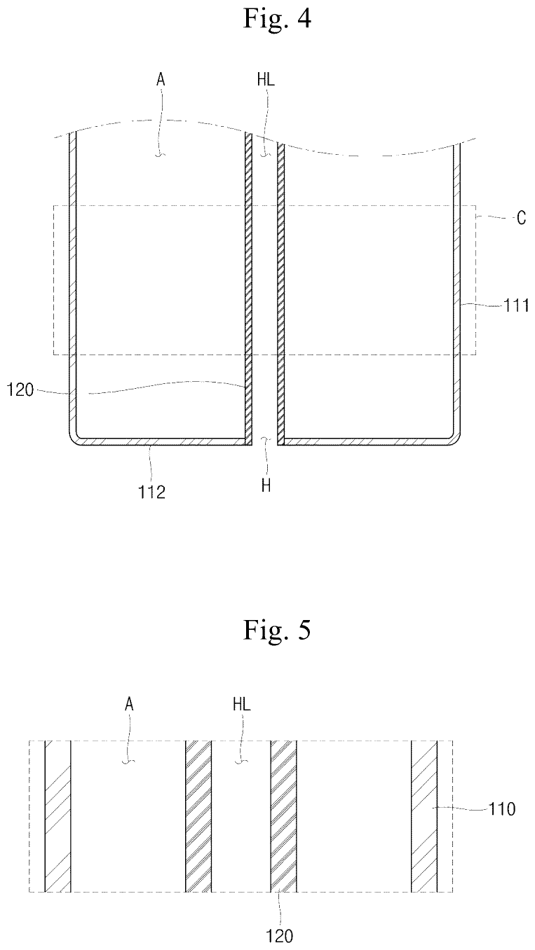

Referring to FIGS. 1 to 4, the case 100 may include the outer wall part 110 and the inner wall part 120.

The outer wall part 110 may form the exterior of the case 100. The outer wall part 110 may include the body portion 111 and the bottom portion 112, with the body portion 111 and the bottom portion 112 being connected. The upper portion of the body portion 111 may open.

The body portion 111 may include an inwardly deformed beading part 130 and an inwardly bent crimping part 140. The crimping part 140 may be bent at one end of the opening of the body portion. The beading part 130 may prevent the electrode assembly 200 from moving in the case 100. The beading part 130 also may facilitate the fixation of the insulating gasket 500 and the cap assembly 300. The crimping part 140 may firmly fix the cap assembly 300 by pressing the edge of the cap assembly 300 through the insulating gasket 500.

The bottom portion 112 may include a hole H. The inner wall part 120 may be disposed inside of the outer wall part 110, and the inner wall part 120 may extend to the bottom portion 112. The inner wall part 120 may include a hollow part HL. The hollow part HL may correspond to the hole H. Accordingly, the case 100 may be open to outside by the hollow prat HL and the hole H. In one example, the bottom surface of the case 100 is formed in a donut shape.

The accommodation space A of the case may be formed between the outer wall part 110 and the inner wall part 120. The electrode assembly 200 may be disposed in the accommodation space A. Accordingly, the diameter of the inner wall part 120 may be different from the inner diameter of the core part 250 of the electrode assembly. In detail, the inner diameter of the core part 250 may be greater than the diameter of the inner wall part 120. Therefore, the inner wall part 120 may be inserted into opening at the center of the core part 250. Thus, the core part 250 may overlap with the hollow part HL and the hole H.

The cap assembly 300, the first current collector plate 710, and the second current collector plate 720 may each include a hole. For example, at least one of the cap up 310, the safety vent 320, or the cap down 330 can include a hole that overlaps with the hollow part HL. Similarly, at least one of the first current collector plate 710 or the second current collector plate 720 may include a hole that overlaps with the hollow part HL. Accordingly, the hole of the cap assembly, the hole of the current collector plate, the hollow part HL of the inner wall part, and the hole H of the bottom portion may overlap. Thus, the secondary battery 1000 may include a through hole TH about which the upper and lower parts are provided. With such a configuration, a cooling member may be inserted into the through hole TH of the secondary battery. And when forming a battery module including a plurality of secondary batteries, the cooling member may be inserted into the through hole TH of each of the secondary batteries.

Conventionally, a cooling member may be disposed at the edge of a battery module. In such a configuration, the location where the cooling member is positioned is limited, and cooling efficiency is reduced. Also, it is difficult to cool heat generated in the core part of the electrode assembly of each secondary battery.

Secondary batteries according to embodiments include an inner wall part including the hollow part as described above. Therefore, the secondary battery may include a through hole as described above. In detail, the through hole is formed by overlapping the hollow part, the hole of the cap assembly, the hole of the current collector plate, and the hole of the bottom portion. As such, an additional cooling member may be inserted into the through hole. Accordingly, the cooling of the secondary battery may be improved. Heat may be generated in the core part of the electrode assembly, for example, during charging and discharging of the secondary battery. However, the provision of the cooling member as described herein may effectively prevent any problems caused by the heat. Accordingly, a fire due to heating in a secondary battery according to embodiments of the present disclosure may be prevented. And, thus, the life and safety of the secondary battery may be improved.

Further, the inner wall part may limit deformation of the electrode assembly. In detail, deformation of the outer diameter of the electrode assembly is limited by the outer wall part, and deformation of the inner diameter of the electrode assembly is limited by the inner wall part. Accordingly, stress may be prevented from being concentrated on the core part of the electrode assembly. And heat generated due to stress in the core part of the electrode assembly may be prevented or reduced. Thus, a secondary battery according to embodiments of the present disclosure may have improved life and safety.

FIGS. 5 to 9 are views of outer wall parts and inner wall parts according to embodiments of the disclosure.

Referring to FIG. 5, the outer wall part 110 and the inner wall part 120 may have the same or similar thickness. In other embodiments, the outer wall part 110 and the inner wall part 120 may have different thicknesses. For example, the thickness of the inner wall part 120 may be greater than the thickness of the outer wall part 110. Accordingly, the heat transfer effect of the inner wall part 120 may increase. Accordingly, the heat generated in the core part of the electrode assembly may be effectively cooled by the cooling member.

The outer wall part 110 and the inner wall part 120 may be made from the same material. Accordingly, the manufacturing process of the outer wall part 110 and the inner wall part 120 is facilitated. That is, the case may be manufactured by a single injection molding process. In other embodiments, the outer wall part 110 and the inner wall part 120 may include different materials. For example, the outer wall part 110 and the inner wall part 120 may be formed separately and coupled to each other by welding. Accordingly, the physical properties of the outer wall part 110 and the inner wall part 120 may be made different.

In some examples, the outer wall part 110 and the inner wall part 120 may include metal. Further, the outer wall part 110 and the inner wall part 120 may be made from different metals. Accordingly, the outer wall part 110 and the inner wall part 120 may have different strengths. For example, the strength of the inner wall part 120 may be greater than the strength of the outer wall part 110. In this regard, the inner wall portion 120 includes the hollow part HL, and the strength of the inner wall part 120 may be reduced by the hollow part HL. Accordingly, the inner wall part 120 may include a metal having relatively high strength.

The outer wall part 110 and the inner wall part 120 may include at least one of a metal or a non-metal. For example, the outer wall part 110 may include a metal and the inner wall part 120 may include a non-metal. In a more particular example, the inner wall part 120 may include a resin. Therefore, the outer wall part 110 may be electrically conductive and the inner wall part 120 may not be electrically conductive. In such a case, the outer wall part 110 may be electrically connected to the second electrode 220 and may function as the negative electrode. But the inner wall part 120 is connected to the outer wall part 110, and the secondary battery may contact the first electrode 210 and the inner wall part 120, for example, due to an external impact. And if the inner wall part 120 includes a conductive material, a short circuit between the first electrode 210 and the second electrode 220 may occur. But if the inner wall part 120 is formed from a non-conductive material, the short circuit may not occur. Accordingly, the safety of the secondary battery may be improved.

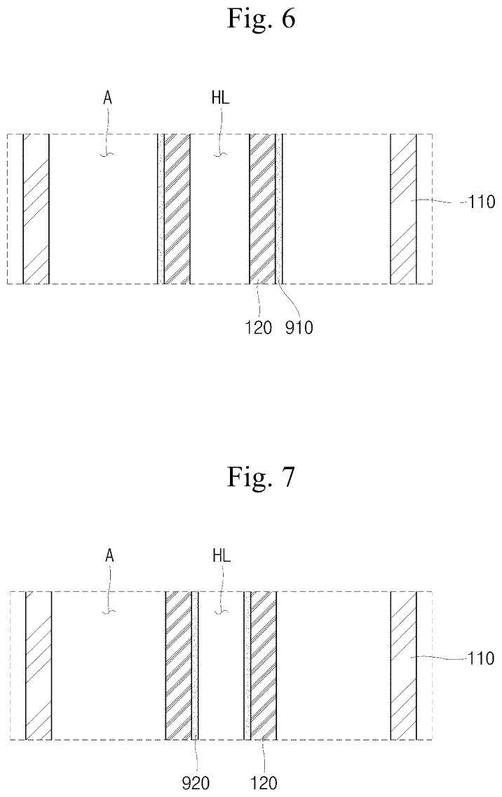

Referring to FIGS. 6 and 7, the inner wall part 120 may include a first surface and a second surface opposite to the first surface. The first surface may be an outer surface of the inner wall part 120, and the second surface may be an inner surface of the inner wall part 120. That is, the first surface may face the outer wall part 110.

A protective layer may be disposed on at least one surface of the first surface or the second surface. For example, referring to FIG. 6, a first protective layer 910 may be disposed on the first surface. As discussed above the electrode assembly 200 is disposed in the accommodation space A between the outer wall part 110 and the inner wall part 120. The electrode assembly 200 and the inner wall part 120 may contact each other, for example, due to an external impact or an error during a processing of the secondary battery. And the outer wall part 110 and the inner wall part 120 are in contact with each other. Thus, when the inner wall part 120 includes a conductive material, a short circuit between the first electrode 210 and the second electrode 220 may occur due to the electrode assembly 200 and the inner wall part 120. But when the first protective layer 910 disposed on the first surface may include a non-conductive material. For example, the first protective layer 910 may include an insulating material. Thus, the insulation provided by the first protective layer 910 may prevent a short circuit between the first electrode 210 and the second electrode 220 that may occur when the first electrode 210 and the inner wall part 120 contact each other.

Referring to FIG. 7, a second protective layer 920 may be disposed on the second surface. The second protective layer 920 may be disposed on the inner surface of the hollow part HL. As described above, the cooling member may be inserted into the through hole TH. When the cooling member is inserted, the cooling member and the inner wall part 120 may contact each other. Accordingly, a crack may occur in the inner wall part 120. But the second protective layer 920 disposed on the second surface may include a different material from the inner wall part 120. For example, the second protective layer 920 may include a material having a higher strength than the inner wall part 120. As such, the second protective layer 920 may be a reinforcing layer. Therefore, it is possible to prevent cracks in the inner wall part that may occur if the cooling member and the inner wall part 120 contact each other.

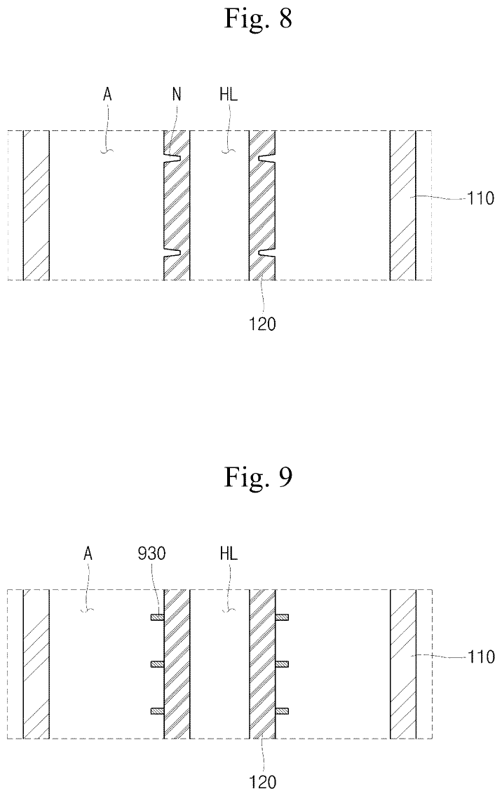

Referring to FIG. 8, the inner wall part 120 may include at least one groove N. The groove N may be formed on at least one of the first surface or the second surface of the inner wall part 120. The groove N may extend along the outer diameter of the inner wall part 120. The groove N may be a notch formed in the inner wall part 120. The thickness of the region where the groove is formed may be less than the thickness of other regions.

As described above, the electrode assembly 200 and the electrolyte may be accommodated in the accommodation space A. When the temperature of the secondary battery increases, the electrolyte vaporizes, generating heat and pressure. The safety vent 320 and the cap down 330 may become separated by the pressure, and the safety vent 320 may be cut along the notch 320a (see FIG. 1). The cut safety vent 320 may prevent an explosion of the secondary battery by releasing the gas to outside of the secondary battery.

In the prior art, the gas moves upward through the core part of the electrode assembly. However, the secondary battery according to embodiments of the present disclosure includes the inner wall part. Accordingly, the gas moves through the gap between the electrode assembly and the inner wall part, and the gas may not easily move toward the cap assembly. But when the inner wall part 120 includes the groove N, the inner wall part 120 may be broken at the groove N. For example, the pressure of the gas may act toward the inner wall part, and the inner wall part 120 then may be easily broken at the groove N. Accordingly, the gas may be discharged to outside of the secondary battery through the through hole TH.

Referring to FIG. 9, the inner wall part 120 may include at least one protrusion 930. The protrusion 930 may be disposed on the first surface. The inner wall part 120 and the protrusion 930 may be formed from the same or different materials. For example, when the inner wall part 120 may include a resin material, the inner wall part 120 and the protrusion 930 may include the same resin material. Accordingly, the inner wall part 120 and the protrusion 930 may be formed integrally. In another example, when the inner wall part 120 includes a metal, the inner wall part 120 and the protrusion 930 may be formed from different materials. That is, the protrusion 930 may be formed from a resin material and the inner wall part may be formed from a metal.

As described above, the electrode assembly 200 may be accommodated in the accommodation space A. And when the electrode assembly 200 and the inner wall part 120 contact each other, the first electrode 210 and the second electrode 220 may be short-circuited. But when the inner wall part 120 includes the protrusion 930, contact between the electrode assembly 200 and the inner wall part 120 may be prevented by the protrusion 930. Thus, a short circuit between the first electrode 210 and the second electrode 220 may be prevented. And a secondary battery according to this embodiment may be safer.

The protrusion 930 may include an elastic material. As described above, the electrode assembly 200 can be accommodated in the accommodation space A. In some cases, the protrusion 930 may interfere with insertion of the electrode assembly 200 is inserted into the accommodation space A. But when the protrusion 930 has elasticity interference by the protrusion 930 of the electrode assembly 200 being inserted into the accommodation space A may be prevented. That is, when the electrode assembly 200 is inserted, the protrusion 930 may be bent in the insertion direction of the electrode assembly 200. And, after the electrode assembly 200 is inserted, the protrusion 930 may be restored by its elasticity. Therefore, the electrode assembly 200 may be firmly fixed in the accommodation space A by the protrusion 930. Further, the electrode assembly 200 may be prevented from contacting the inner wall part by the protrusion 930.

The secondary battery according to an embodiment includes the case including the outer wall part and the inner wall part. The inner wall part includes the hollow part, and the electrode assembly is accommodated in the accommodation space between the outer wall part and the inner wall part. The hollow part of the inner wall part connects with the bottom portion of the outer wall part, the hole of the current collector plate, and the hole of the cap assembly. Accordingly, the secondary battery may have a through hole formed through it.

The cooling member may be inserted into the through hole, and the secondary battery may be cooled by the cooling member. Thus, the secondary battery may be made safer by addressing heat generation in the secondary battery.

Further, deformation of the electrode assembly may be reduced or prevented by the inner wall part. In particular, as the electrode assembly shrinks and expands during charging and discharging, the deformation of the core part of the electrode assembly is limited by the inner wall part. Thus, deformation of the electrode assembly may be prevented or reduced, and heat generation due to deformation of the electrode assembly may be reduced. Thus, the secondary battery may be made safter.

The secondary batteries described above may be used in battery modules. A battery module may include a plurality of secondary batteries that are electrically connected to each other. The plurality of secondary batteries may be connected in series and/or parallel.

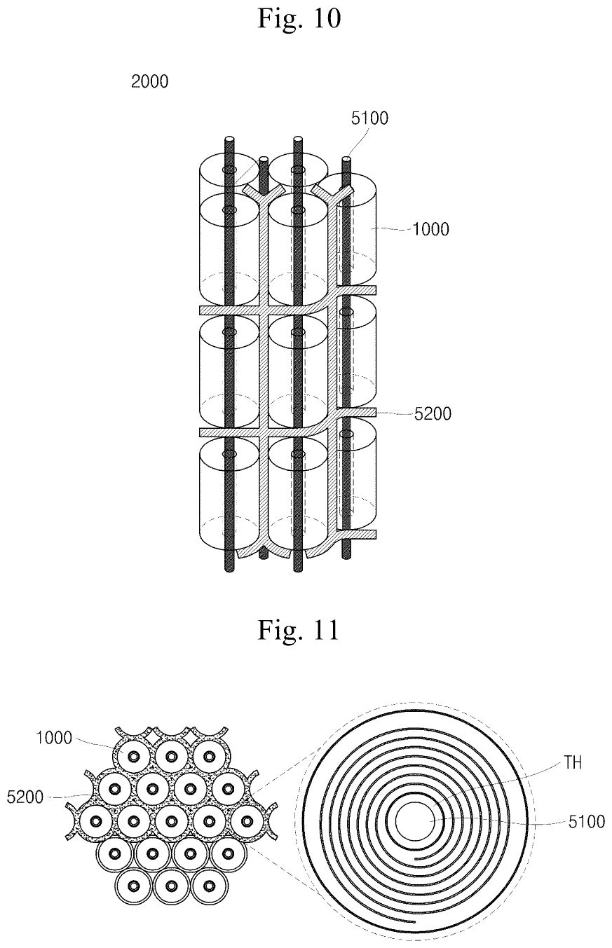

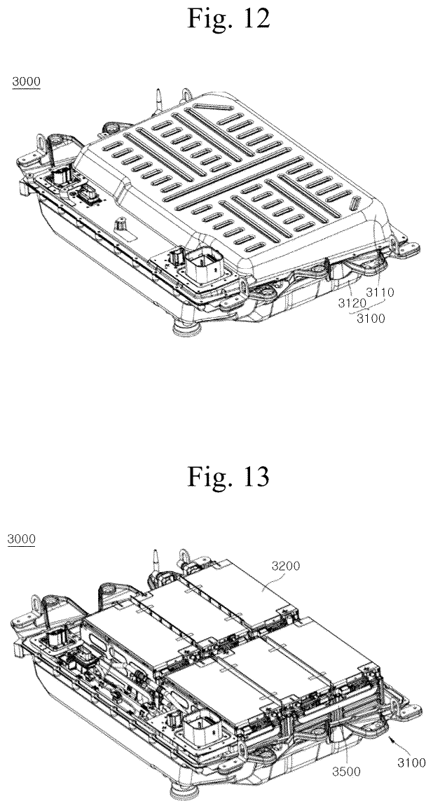

Referring to FIGS. 10 and 11, a battery module 2000 may include a plurality of secondary batteries 1000. Although not shown in the drawings, the plurality of secondary batteries may be connected in serial and/or parallel manners through a bus bar. The battery module 2000 may include the cooling member. The cooling member may include a first cooling member 5100 and a second cooling member 5200.

The first cooling member 5100 may be inserted into through holes TH of the secondary batteries. For example, each of the secondary batteries may be disposed such that the through holes TH overlap each other, and the first cooling member 5100 may be inserted into the through holes of the plurality of secondary batteries.

The second cooling member 5200 may be disposed outside of the secondary batteries 1000. In particular, the second cooling member 5200 may be disposed between the secondary batteries.

The battery module 2000 may therefore be cooled by the first cooling member 5100 and the second cooling member 5200. In prior art, battery modules were cooled only by the cooling members like the second cooling member 5200. And as the size of the prior art battery modules increased, the cooling characteristics of the battery modules decreased.

The battery module according to the embodiments described herein includes secondary batteries having through holes. Accordingly, the battery module may further include the first cooling member disposed in the through holes. Thus, the battery module according to the embodiments may have improved cooling characteristics.

The secondary battery and battery module according to embodiments of the present disclosure may be used to manufacture a battery pack.

FIGS. 10 and 11 show a battery pack 3000 according to one or more example embodiments of the present disclosure. The battery pack 3000 may include a plurality of battery modules 3200 and a housing 3100 for accommodating the plurality of battery modules 3200. For example, the housing 3100 may include first and second housings 3110 and 3120 coupled in opposite directions through the plurality of battery modules 3200. The plurality of battery modules 3200 may be electrically connected to each other by using a bus bar 3500, and the plurality of battery modules 3200 may be electrically connected to each other in a series/parallel or series-parallel mixed method, thereby obtaining desired (e.g., required) electrical output. In the drawing, for convenience of illustration, parts such as bus bars, cooling units, and external terminals for electrical connection of secondary battery are omitted. In one or more example embodiments, battery pack 3300 may be mounted in a vehicle. The vehicle may be or include, for example, an electric vehicle, a hybrid vehicle, or a plug-in hybrid vehicle. A vehicle may include a four-wheeled vehicle or a two-wheeled vehicle.

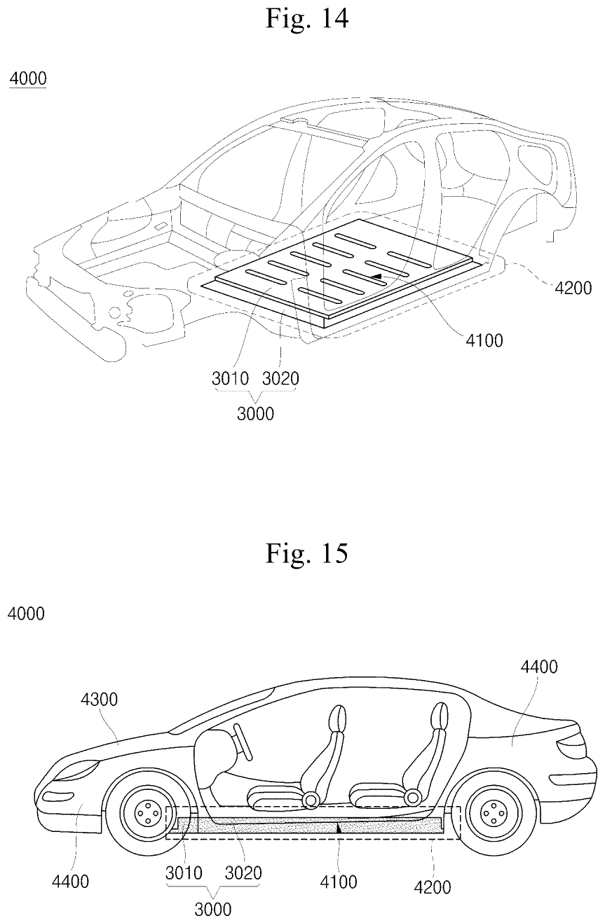

In FIG. 14, a battery pack 3000 may include a battery pack cover 3010, which is a part of a vehicle underbody 4100 and may correspond to the first housing, and a pack frame 3020, which is disposed under the vehicle underbody 4100 and may corresponding to the second housing. The battery pack cover 3010 and the pack frame 3020 may be, e.g., integrally formed with a vehicle floor 4200. The vehicle underbody 4100 separates the inside and outside of a vehicle, and the pack frame 3020 may be disposed outside the vehicle

In FIG. 15, a vehicle 4000 may be formed by combining additional parts, such as a hood 4300 in front of the vehicle 4000 and fenders 4400 respectively located in the front and rear of the vehicle 4000 to a vehicle body part. The vehicle 4000 may include the battery pack 3000 including the battery pack cover 3010 and the pack frame 3020, and the battery pack 3000 may be coupled to the vehicle body part.

The above is only one embodiment for implementing a secondary battery according to the disclosure, the disclosure is not limited to the above embodiment, and there is a technical spirit of the disclosure to the extent that various modifications can be made by anyone having ordinary skill in the art to which the disclosure pertains without departing from the gist of the disclosure.

What is claimed is:

1. A secondary battery comprising:
a case comprising an accommodation space, the case including an outer wall and an inner wall, with the outer wall including a body portion and a bottom portion, with the bottom portion including an opening;
an electrode assembly accommodated in the accommodation space; and
a cap assembly sealing an opening of the case,
wherein the inner wall is disposed on the bottom portion,
wherein the inner wall comprises a hollow part adjacent to the opening, and
wherein thicknesses of the outer wall and the inner wall are different.

2. The secondary battery as claimed in claim 1, wherein the accommodation space is formed between the outer wall and the inner wall.

3. The secondary battery as claimed in claim 1, wherein the cap assembly comprises a cap up, a cap down under the cap up, and a safety vent between the cap up and the cap down, and
wherein the cap up, the cap down, and the safety vent comprise a hole corresponding to the opening of the bottom portion and the hollow part.

4. The secondary battery as claimed in claim 3, further comprising a first current collector plate positioned above the electrode assembly and a second current collector plate positioned under the electrode assembly, and
wherein the first current collector plate and the second current collector plate comprises a hole corresponding to the opening of the bottom portion and the hollow part.

5. The secondary battery as claimed in claim 1, wherein the electrode assembly comprises a core part, and
wherein a diameter of the hollow part is greater than a diameter of the inner wall.

6. The secondary battery as claimed in claim 1, wherein the outer wall and the inner wall are formed from the same material.

7. The secondary battery as claimed in claim 1, wherein the outer wall and the inner wall are formed from different materials.

8. The secondary battery as claimed in claim 1, wherein the outer wall and the inner wall are formed from different metals.

9. The secondary battery as claimed in claim 1, wherein a strength of the inner wall is greater than a strength of the outer wall.

10. The secondary battery as claimed in claim 1, wherein the outer wall part comprises metal and the inner wall part comprises resin.

11. The secondary battery as claimed in claim 1, wherein the inner wall comprises an outer surface and an inner surface, and
wherein a protective layer is disposed on at least one of the inner surface or the outer surface.

12. The secondary battery as claimed in claim 11, wherein a protective layer is disposed on the outer surface, and
wherein the protective layer comprises an insulating material.

13. The secondary battery as claimed in claim 11, wherein a protective layer is disposed on the inner surface, and
wherein the protective layer comprises a material having a greater strength than the inner wall.

14. The secondary battery as claimed in claim 11, wherein a first protective layer is disposed on the outer surface,
wherein a second protective layer is disposed on the inner surface,
wherein the first protective layer comprises an insulating material, and
wherein the second protective layer comprises a material having a higher strength than the inner wall.

15. The secondary battery as claimed in claim 1, wherein the inner wall comprises an outer surface and an inner surface, and
wherein a groove is formed in at least one of the outer surface and the inner surface.

16. The secondary battery as claimed in claim 15, wherein the groove is a notch extending along an outer diameter of the inner wall.

17. The secondary battery as claimed in claim 1, wherein the inner wall comprises an outer surface and an inner surface, and
wherein the inner wall comprises at least one protrusion disposed on the outer surface.

18. The secondary battery as claimed in claim 17, wherein the protrusion and the inner wall are formed from the same material.

19. The secondary battery as claimed in claim 17, wherein the protrusion and the inner wall are formed from different materials.

20. The secondary battery as claimed in claim 17, wherein the protrusion comprises an elastic material.
